(19) United States
(12) Patent Application Publication
(10) Pub. No.: US 2026/0017709 A1
(43) Pub. Date: Jan. 15, 2026

(54) CONTROL DEVICE FOR CONTROLLING DISPLAY DEVICE PROVIDED AT SEAT

(71) Applicant: FOOD & LIFE COMPANIES LTD., Osaka (JP)

(72) Inventor: Hiroshi OGAWA, Suita Osaka (JP)

(21) Appl. No.: 19/334,989

(22) Filed: Sep. 22, 2025

Related U.S. Application Data
(63) Continuation of application No. PCT/JP2024/020912, filed on Jun. 7, 2024.

(30) Foreign Application Priority Data
Jun. 14, 2023 (JP) 2023-098020

(51) Int. Cl. G06Q 30/0601; G06F 3/0482; G06F 3/0484; G06Q 50/12

(52) U.S. Cl. CPC G06Q 30/0643; G06F 3/0482; G06F 3/0484; G06Q 50/12

(57) ABSTRACT

To improve convenience for the customer, a control device including a control unit for displaying in a first area, images of a plurality of orderable items, and displaying, in a second area, an image of an item selected as an order candidate and an order button for ordering the item; and displaying the image of the selected item in the second area, in response to an operation indicating selection of the image of the item in the first area, in a display device provided at a seat.

### CROSS-REFERENCE TO RELATED APPLICATION

This application is a continuation of International Patent Application No. PCT/JP2024/020912 filed June 7. 2024, which is based upon and claims the benefit of priority from Japanese Patent Application No. 2023-098020, filed on June 14. 2023, the entire contents of which are incorporated herein by reference.

### BACKGROUND OF THE INVENTION

### Technological Field

The present invention relates to a control device.

### BACKGROUND ART

Various systems for accepting customer orders have been conventionally proposed for establishments providing food and beverages. For example, Patent Document 1 below discloses a technology that detects a customer's selection action on image data of food and beverages being scroll-displayed on a display unit, and displays data related to the selected food and beverage on the display unit through masking processing.

### PRIOR ART DOCUMENTS

### PATENT DOCUMENTS

[Patent Document 1] Japanese Patent No. 5715942

### SUMMARY OF THE INVENTION

### Problem To Be Solved By The Invention

However, there is still a demand for providing technology with higher convenience for customers. Such demand is not limited to establishments providing food and beverages as mentioned above, but is common to establishments providing any type of merchandise. The present invention has been made in view of the above circumstances and provides technology that enables improvement of convenience for customers.

### Means for Solving the Problems

According to one aspect of the present invention, a control device is a control device that controls a display device provided on a seat, and comprises: a display means for displaying an order screen on the display device, the order screen being used by a customer seated on the seat to order products. The order screen includes a product movement area, which is a region for displaying images of a plurality of products along a lane to move in a predetermined direction; an order candidate area provided at a position that does not overlap with the product movement area; and an order execution button provided at a position that does not overlap with the product movement area. The control device further comprises: a selection acceptance means for accepting the selection of products displayed in the product movement area; a movement display means for moving and displaying the products whose selection has been accepted by the selection acceptance means from the product movement area to the order candidate area; a button operation acceptance means for accepting an operation of the order execution button; and an order execution means for executing the order of the products displayed in the order candidate area when an operation is accepted by the button operation acceptance means.

A control device according to another aspect of the present invention is a control device that controls a display device provided on a seat, and comprises: a display means for displaying an order screen on the display device, the order screen being used by a customer seated on the seat to order products. The order screen includes a product movement area, which is a region for displaying images of a plurality of products to be ordered to move along a lane in a predetermined direction. The control device further comprises: an information acquisition means for acquiring information about the customer; and a selection means for selecting, based on the information about the customer, products to be preferentially displayed to the customer from among the plurality of products whose images are displayed in the product movement area, such products being referred to as priority display products.

A control device according to a further aspect of the present invention is a control device that controls a display device provided on a seat, and comprises an order screen display means for displaying an order screen on the display device, the order screen being used by a customer seated on the seat to order products. The order screen includes a product movement area, which is a region for displaying images of each of a plurality of images, including images of products to be ordered and images showing campaign information, to move along a lane in a predetermined direction. The control device further comprises: an operation acceptance means for accepting a predetermined operation on the images showing campaign information; and a campaign display means for displaying a campaign display area, which shows the content of a campaign corresponding to the campaign information, on the order screen when the predetermined operation is accepted by the operation acceptance means.

A control device according to a further aspect of the present invention is a control device that controls a display device provided on a seat, and comprises an order screen display means for displaying an order screen on the display device, the order screen being used by a customer seated on the seat to order products. The order screen includes a product movement area, which is a region for displaying images of each of a plurality of products to be ordered to move along a lane in a predetermined direction. The control device further comprises: an operation acceptance means for accepting a flick operation having a component in a direction opposite to the predetermined direction; and an opposite display means for displaying each of the images of the plurality of products to move in the opposite direction temporarily when the flick operation is accepted by the operation acceptance means.

### Effects of the Invention

According to the present invention, it is possible to improve convenience for customers.

### BRIEF DESCRIPTION OF DRAWINGS

FIG. 1 is a schematic block diagram showing a system configuration of a management system 100 according to the present invention.

FIG. 2 is a diagram showing a specific example of an external appearance of an establishment system 110.

FIG. 3 is a diagram showing a specific example of an order screen.

FIG. 4 is a diagram showing a specific example of display changes when customers perform item ordering operations.

FIG. 5 is a diagram showing a specific example of display changes when customers perform item ordering operations.

FIG. 6 is a diagram showing a specific example of a support setting screen.

FIG. 7 is a diagram for explaining an item display function.

FIG. 8 is a diagram showing an example where a campaign information item image 432 is displayed.

FIG. 9 is a diagram showing an example of a screen when campaign information is operated.

FIG. 10 is a diagram showing an example of a screen when campaign information is operated.

FIG. 11 is a diagram showing a specific example of a menu screen 436.

FIG. 12 is a schematic block diagram showing a specific example of the management device 20.

FIG. 13 is a diagram showing a specific example of a customer information table.

FIG. 14 is a schematic block diagram showing a specific example of an establishment control device 30.

FIG. 15 is a flowchart showing a specific example of processing performed by the establishment control device 30.

FIG. 16 is a diagram showing a schematic overview of an example hardware configuration of an information processing device 90 applicable to the present embodiment.

### DETAILED DESCRIPTION OF THE INVENTION

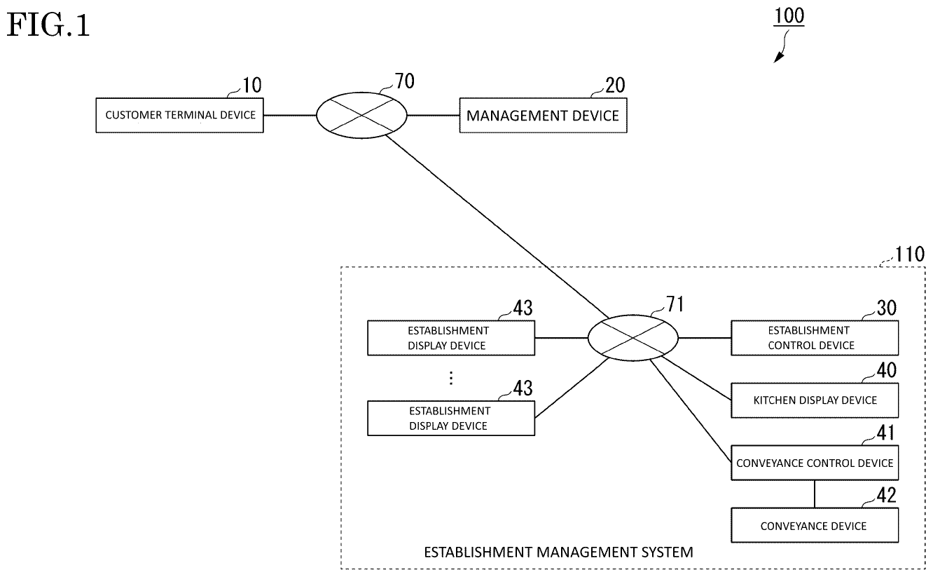

FIG. 1 is a schematic block diagram showing the system configuration of the management system 100 according to the present invention. The management system 100 includes a customer terminal device 10, a management device 20, and an establishment system 110. The customer terminal device 10, the management device 20, and the establishment system 110 are communicably connected via a network 70. The network 70 may be a network using wireless communication or a network using wired communication. The network 70 may be configured using the Internet, or may be configured using a Local Area Network (LAN). The network 70 may be configured by combining multiple networks.

The customer terminal device 10 is a terminal device used by a customer who orders and receives items at establishments managed by the management system 100. The managed establishments may be, for example, establishments that provide food and beverages to customers. In this case, the items are food and beverages. However. the items provided to customers at the managed establishments are not limited to food and beverages. The customer terminal device 10 is an information processing device such as a smartphone, mobile phone, personal computer, tablet terminal, portable game console, wearable computer, etc. The customer terminal device 10 is capable of communicating with other devices via network 70.

The management device 20 is a device that manages the establishment system 110 installed in establishments that are management targets of the management system 100. The management device 20 is configured using an information processing device such as a personal computer, tablet terminal, or server device. The management device 20 accepts registration of data related to a group of items (hereinafter referred to as “item group data”) that can be provided as menu items in establishments that are management targets of the management system 100. The item group data includes, for example, images of multiple items that can be provided as menu items, and information related to each item (for example, price, information about ingredients, information about preparation, etc.).

Registration of item group data is performed by a person having predetermined authority such as an administrator of the management device 20. The registration of item group data may be performed in any manner. The registration of item group data may be performed by the administrator operating an input/output device (user interface) provided in the management device 20. The registration of item group data may be performed by the administrator transmitting the item group data to the management device 20 from another information processing device.

The establishment system 110 is provided in one or more establishments that are management targets of the management system 100. The establishment system 110 is provided for each establishment where food and beverages are served. In this case, each item included in the item group data is a food or beverage item. The establishment system 110 includes an establishment control device 30, a kitchen display device 40, a conveyance control device 41, a conveyance device 42, and multiple establishment display devices 43. Each device in the establishment system 110 is communicably connected via a network 71 provided in the establishment system 110. The network 71 may be configured using, for example. LAN or wireless LAN.

The establishment control device 30 is a device that controls each apparatus provided in the establishment system 110. The establishment control device 30 is configured using an information processing device such as a personal computer or server device. The establishment control device 30, for example, receives item group data transmitted from the management device 20, determines items to be displayed (hereinafter referred to as “display target items”) on the establishment display device 43 in the establishment system 110, and causes the images of the display target items to be displayed on the establishment display device 43. The establishment control device 30 may also determine items selected on the kitchen display device 40 as display target items.

The kitchen display device 40 is a device used by kitchen managers in the establishment system 110. The kitchen display device 40 is an information processing device such as a smartphone, mobile phone, personal computer. tablet terminal, portable game console, wearable computer, or dedicated terminal. The kitchen display device 40) displays items included in the item group data transmitted from the management device 20 as item candidates. The kitchen display device 40 notifies the establishment control device 30 of items selected by the kitchen manager. Additionally, the kitchen display device 40 displays information regarding orders placed by customers through operations on the establishment display device 43 or customer terminal device 10 (hereinafter referred to as “order information”). The order information may include information indicating the seat where the ordering customer is located, information indicating the ordered items, and information indicating the quantity of ordered items. The kitchen manager prepares and provides items (food and beverages) to customers according to the order information displayed on the kitchen display device 40.

The conveyance control device 41 controls the operation of the conveyance device 42. The conveyance control device 41 may control the operation of the conveyance device 42 according to control signals transmitted from. for example, the establishment control device 30 or the kitchen display device 40. The conveyance device 42 transports items prepared by the kitchen manager to customers. The conveyance device 42 is configured using, for example, a conveyor.

The establishment display device 43 may be an image display device such as a liquid crystal display or an organic EL (Electro Luminescence) display. The establishment display device 43 may be configured as a touch panel further equipped with an input device.

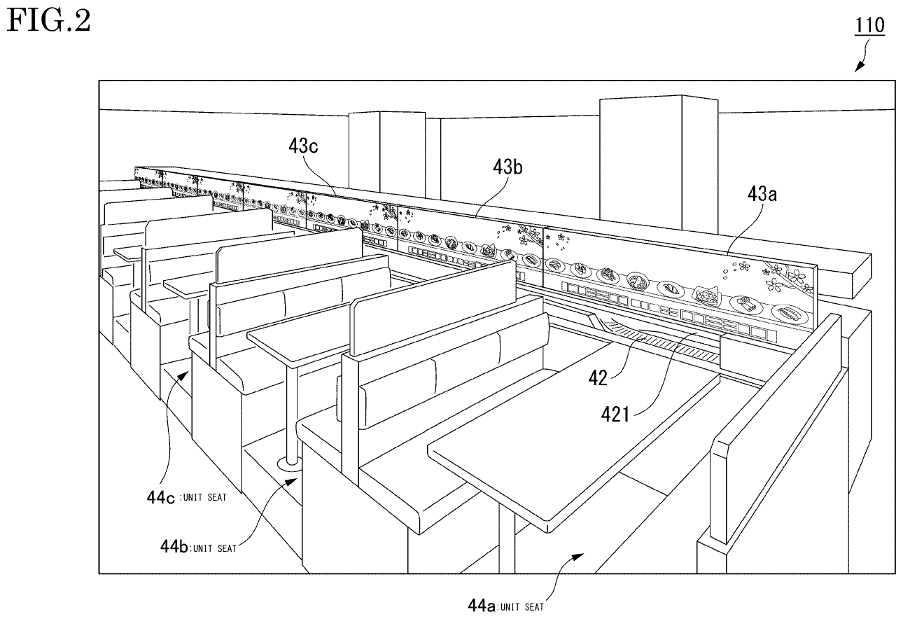

FIG. 2 is a diagram showing a specific example of the external appearance of the establishment system 110. Multiple unit seats 44 are provided in the establishment. A unit seat 44 is a seat used by a group of one or more customers for whom payment is processed together. The unit seat 44 may be configured as a seat used by a single customer (for example, a single-person seat provided at a counter), or as shown in FIG. 2, it may be configured as a seat used by multiple persons. One or more establishment display devices 43 may be provided for each unit seat 44.

In the example of FIG. 2, one establishment display device 43 is provided for one unit seat 44. For example. establishment display device 43a is provided for unit seat 44a. and establishment display device 43b is provided for unit seat 44b. and establishment display device 43c is provided for unit seat 44c.

The conveyance device 42 is provided to be capable of transporting items from at least the kitchen to each unit seat 44. Each unit seat 44 is provided with at least one receiving port 421. The conveyance device 42 is configured to, for example, transport items from the kitchen to the receiving port 421 and stop the items at the receiving port 421.

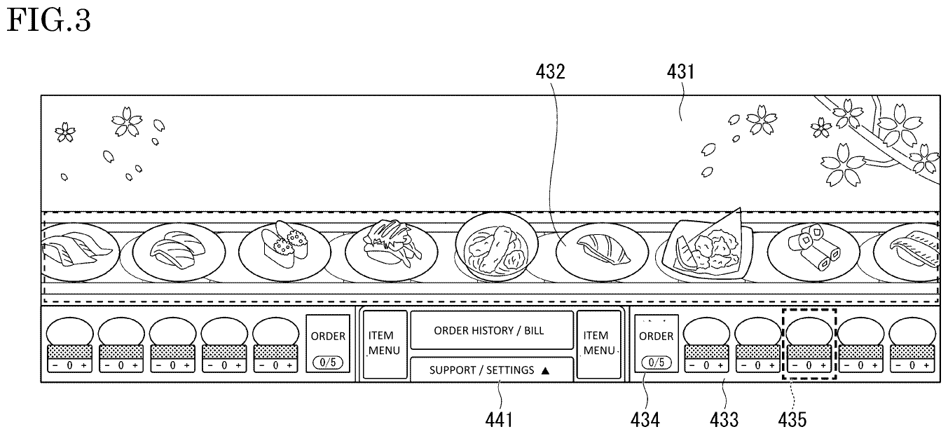

A screen used by customers seated in each unit seat 44 to order items is displayed on the establishment display device 43 provided at each unit seat 44. FIG. 3 is a diagram showing a specific example of the order screen. In the specific example of FIG. 3, at least an image of the conveyance device 42 and one or more item images 432 are displayed. Additionally, as shown in FIG. 3, an information display area 431, an order operation area 433, and a setting operation area 441 may also be displayed.

The image of the conveyance device 42 may be displayed to move at a predetermined speed in a predetermined direction. The item images 432 may be displayed to move at a predetermined speed in a predetermined direction. For example, the image of the conveyance device 42 and each item image 432 may be displayed to move from right to left at a predetermined speed. By displaying the image of the conveyance device 42 and the item images 432 moving at the same speed in the same direction, it appears as if the items represented by each item image 432 are loaded on and moving with the conveyance device 42. More specifically, such display enables customers to view items (for example, sushi) moving along the lane, similar to what one would see in a conveyor belt sushi restaurant.

The establishment control device 30 or the establishment display device 43 may change the speed and direction of movement of these images in response to customer operations. Customer operations may be accepted as operations on the establishment display device 43 configured using a touch panel. For example, in response to a customer performing a flick operation having a component in a direction opposite to a predetermined direction on the touch panel, the image of the conveying device 42 and the item image 432 may be temporarily displayed to move in a direction opposite to the predetermined direction.

The information display area 431 is an area where information to be provided to customers is displayed. The control of what information is displayed in the information display area 431 may be performed by either the management device 20 or the establishment control device 30. For example, information to be provided may be transmitted from the management device 20 to the establishment control device 30 via network 70, and the information selected by the establishment control device 30 may be displayed in the information display area 431. For instance, the displayed information may include advertisements provided to customers, coupon information, or game screens that customers can interact with. The advertisement information provided to customers may be related to the operating entity of the establishment where the establishment system 110 is installed, or it may be related to other entities. In cases where the advertisement is related to other entities, advertising fees may be paid from the advertiser to the establishment's operating entity.

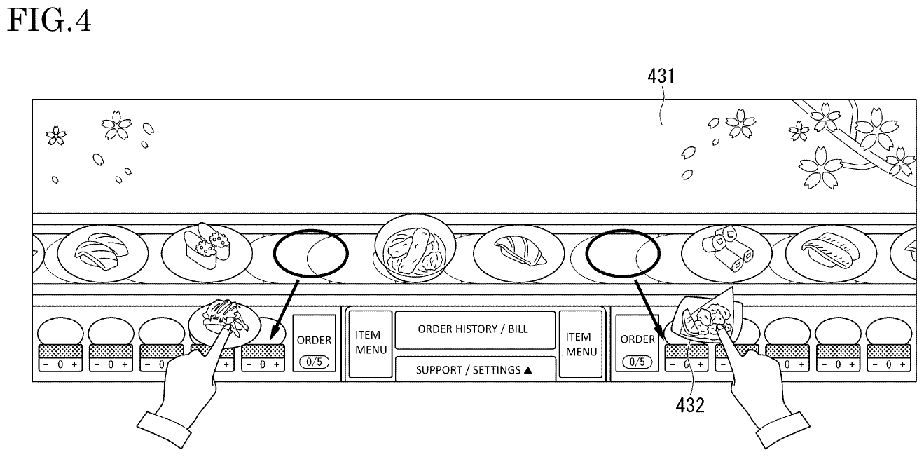

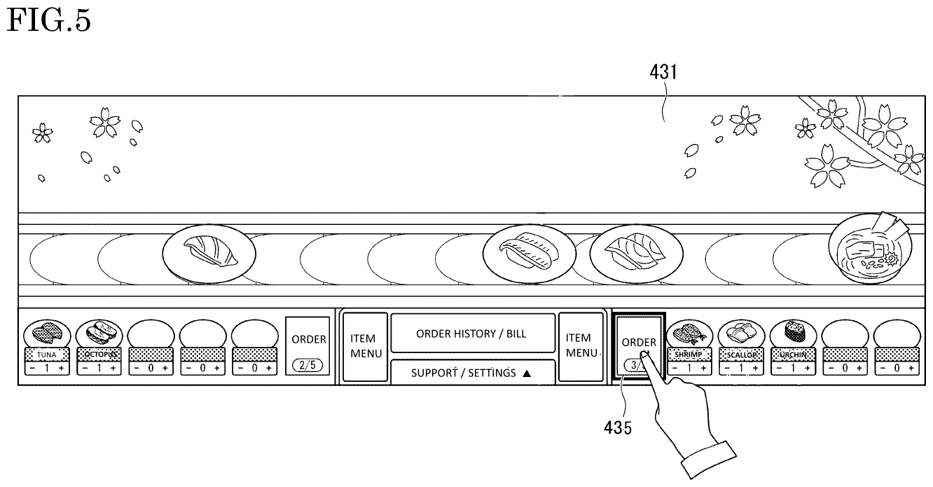

The order operation area 433 is an area used by customers to perform item ordering operations. FIGS. 4 and 5 show specific examples of display changes when customers perform item ordering operations. The order operation area 433 displays an order button 434 and multiple order candidate areas 435. The order button 434 is a button labeled “Order”. The order candidate area 435 is an area that shows items selected by customers as candidates for ordering. As shown in FIG. 3, when a customer has not selected any order candidates, none of the order candidate areas 435 display item images, and instead, an image indicating that no selection has been made is displayed.

When an item image 432 that is to be ordered (desired to be ordered) is displayed on the display screen, the customer performs a selection operation on the item image 432 that is to be ordered. For example, the selection operation may be a drag operation, a tap operation, or another type of operation. In the case of a drag operation. the customer drags the item image 432 to be ordered to the order operation area 433. In the case of a tap operation, the customer taps the item image 432 to be ordered. When the customer performs a selection operation on the item image 432, as shown in FIG. 5, the selected item image 432 is displayed in the order candidate area 435. As described above, the item image 432 displayed in the order candidate area 435 indicates that it has been selected by the customer as a candidate for ordering.

When a customer operates the order button 434, an order is executed for the items shown by the item images 432 displayed in the order candidate area 435 at the time of the operation. When an item order is executed, the establishment control device 30 registers information indicating the identification information of the unit seat 44 where the order was placed and identification information indicating the ordered items. The establishment control device 30 displays this information on the kitchen display device 40. Based on the information displayed on the kitchen display device 40, the kitchen manager (for example, the person preparing the food) prepares the items, places them on the conveyance device 42, and has them transported to the destination (the unit seat 44 where the ordering customer is located). The transported items (ordered items) are conveyed by the conveyance device 42 to the receiving port 421 of the unit seat 44 where the ordering customer is located. The customer who placed the order can retrieve the items that have been transported to the receiving port 421.

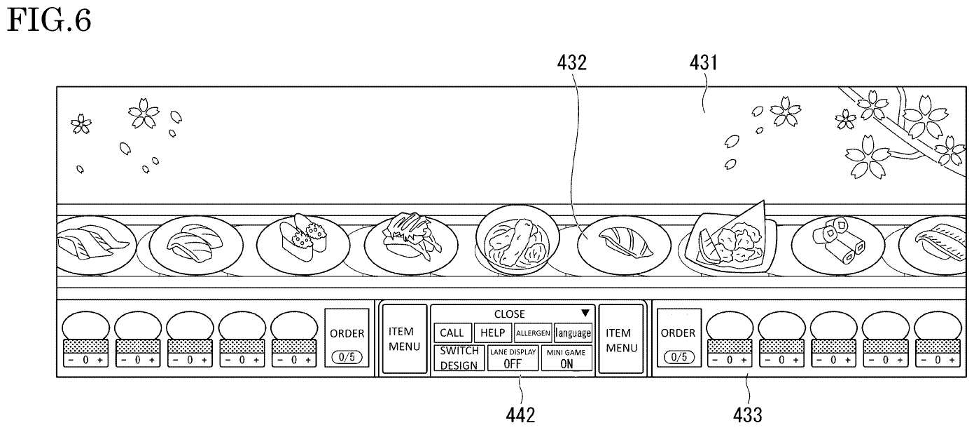

The setting operation area 441 displays a Support Settings button, an Item Menu button, and an Order History/Payment (Bill) button. When the Support Settings button is operated, a support settings screen is displayed. FIG. 6 is a diagram showing a specific example of the support settings screen. In FIG. 6, the support settings screen 442 is displayed by replacing part or all of the area where the setting operation area 441 was previously displayed. The support settings screen displays a call button, an operation explanation tutorial (help) button, an allergen information button, a language selection button, a design switch button, an ON/OFF button for displaying information about items on the lane, and an ON/OFF button for mini-games.

When the call button is operated, an output indicating that the call button has been operated at the unit seat 44 (FIG. 2) where the call button was operated is performed through an output device provided in the establishment system 110 shown in FIG. 1. For example, a lamp provided for each unit seat 44 may be illuminated, or seat identification information of the unit seat 44 may be displayed or output by voice.

When the operation instruction tutorial (help) button is operated, an operation instruction screen is displayed. On the operation instruction screen, videos or still images explaining the operation content may be displayed. When the allergen information button is operated, information regarding allergens in items provided at that establishment is displayed. For example, a table showing the relationship between the provided items and allergen-causing substances may be displayed.

When the language selection button is operated, multiple language buttons for other languages are displayed. For example, language buttons for English, French, German, Spanish, Chinese, and Korean may be displayed. When a language button is operated, the display on the establishment display device 43 is performed in the language assigned to the operated language button. When the design switching button is operated, the display design of the establishment display device 43 is switched to another design. Note that the effects of operating the language selection button and the design switching button are limited to the establishment display device 43 on which the operation was performed.

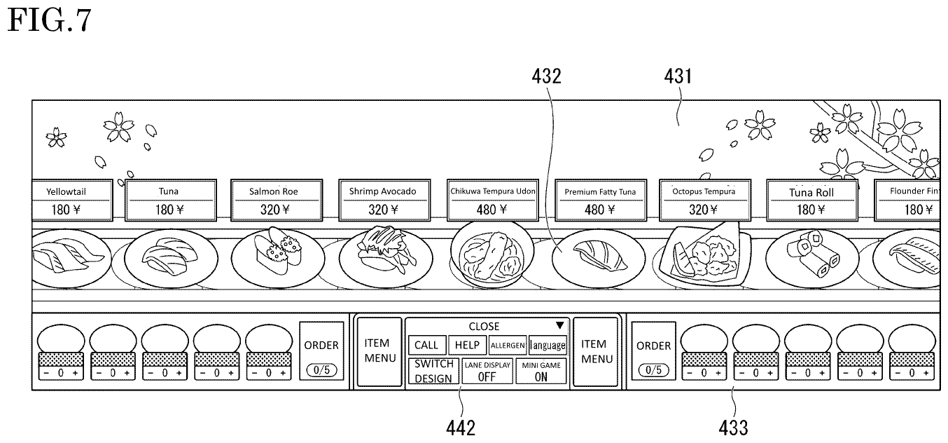

When the item information display ON/OFF button for the lane is operated, the item information display function switches between on and off states. In the state shown in FIG. 6, the item information display function is turned off. Therefore, item information (such as item name and price) is not displayed for each item image 432 flowing in the lane on the screen. FIG. 7 is a diagram for explaining the item display function. In FIG. 7, the item information display function is turned on. In this case, item information is displayed for each item image 432 flowing in the lane on the screen. In the specific example of FIG. 7, the item name and item price are displayed as item information. The display area for item information is arranged for each item image 432 flowing in the lane and moves in synchronization with the movement of the item image 432. As a result, it appears as if the item image 432 and the tag image showing the item information are flowing together along the lane.

When the mini-game ON/OFF button is operated, a mini-game can be played using part or all of the screen of the establishment display device 43. For example, in response to the operation of the mini-game ON/OFF button. the mini-game application is launched and the mini-game screen is displayed. Subsequently, customers can play the mini-game by operating the control buttons displayed on the establishment display device 43. Coupons may be issued or prizes may be provided based on the performance in the mini-game.

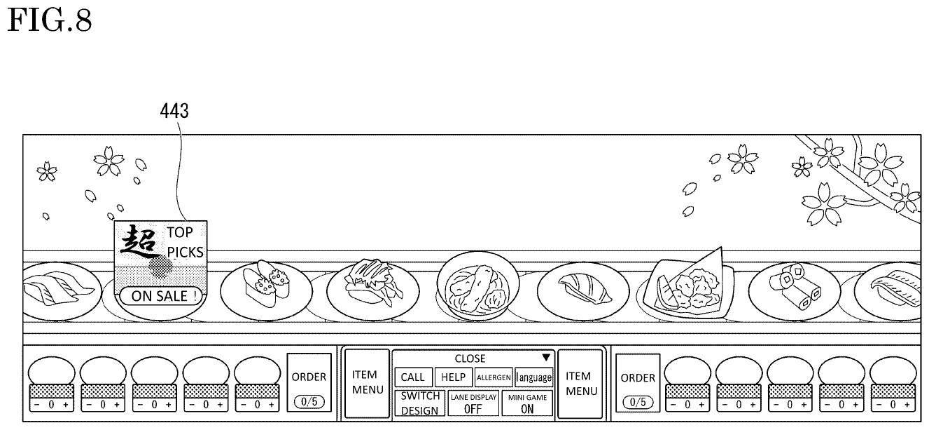

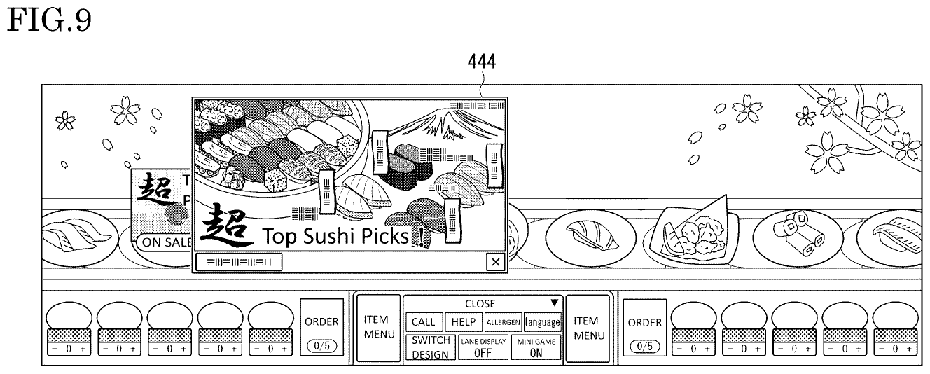

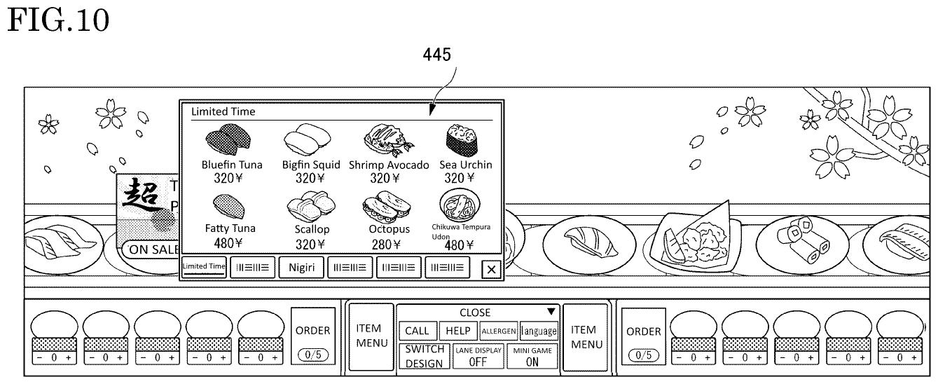

FIG. 8 is a diagram showing an example where a campaign information item image 432 is displayed. Instead of the item image itself, an image 432 indicating a campaign being conducted at the establishment may be displayed on the lane of the establishment display device 43. FIGS. 9 and 10 are diagrams showing example screens when campaign information is operated. When the image indicating a campaign is operated, a campaign display area 444 showing the content of the campaign is displayed. The campaign display area 444 is displayed in a layer above the lane image and other item images 432. Therefore, while the campaign display area 444 is displayed statically, the lanes and item images 432 in the background may continue to flow.

When a menu button is operated in the campaign display area 444, text or images (campaign menu images) 445 indicating the menu are displayed in the campaign display area 444 (FIG. 9). FIG. 10 shows a specific example where the campaign menu image 445 is displayed. The campaign menu image 445 displayed in the campaign display area 444 shows images, names, and prices of items available in that campaign. When a specific item is selected in the campaign menu image 445, the selected item is displayed in the order candidate area 435 and becomes available for ordering.

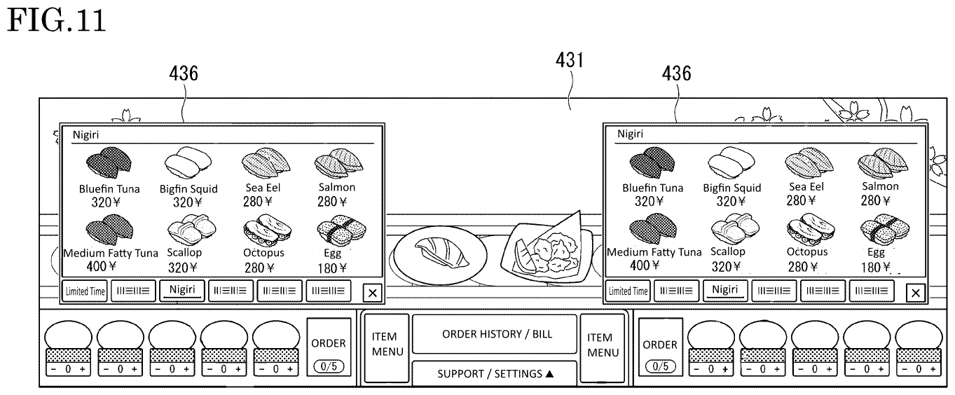

FIG. 11 is a diagram showing a specific example of a menu screen 436. When any one of the buttons on the menu selection screen is operated, a menu screen 436 corresponding to the operated button is displayed. The menu screen 436 may, for example, be displayed superimposed on the item image 432 in the area where the item image 432 (FIG. 7) is displayed. In this case, the position of the menu screen 436 is displayed fixed, but each item image 432 may continue to move in a predetermined direction at a predetermined speed. The menu screen 436 displays buttons related to one or more items. Items selected on the menu screen 436 (for example, items whose buttons are operated) are displayed in the order candidate area 435 (FIG. 5). Thus, the operation to select items for ordering may be implemented in various ways, such as dragging and dropping item images 432 to the order candidate area 435, operating buttons displayed on the menu screen 436, or through other methods.

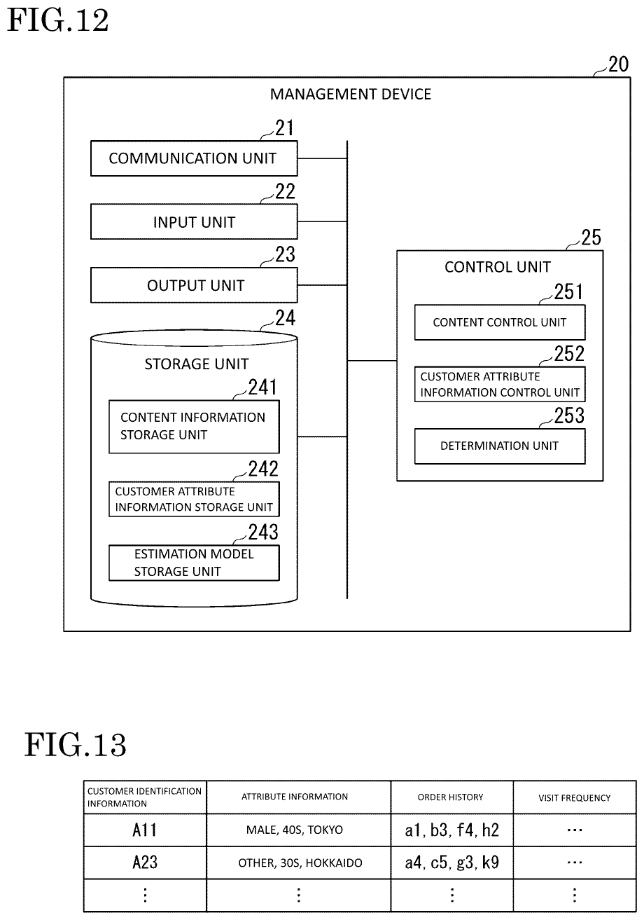

FIG. 12 is a schematic block diagram showing a specific example of the management device 20. The management device 20 is configured using an information device such as a personal computer or a server device. The management device 20 includes a communication unit 21, an input unit 22, an output unit 23, a storage unit 24, and a control unit 25.

The communication unit 21 is a communication device. The communication unit 21 may be configured as a network interface, for example, The communication unit 21 performs data communication with other devices via the network 70 in response to control from the control unit 25. The communication unit 21 may be either a wireless communication device or a wired communication device.

The input unit 22 is configured using existing input devices such as a keyboard, pointing devices (mouse, tablet, etc.), buttons, and touch screen. The input unit 22 is operated by the user (administrator) of the management device 20 when inputting instructions to the management device 20. The input unit 22 may be an interface for connecting input devices to the management device 20. In this case, the input unit 22 inputs input signals generated in response to the administrator's input at the input device to the management device 20. The input unit 22 may be configured using a microphone and voice recognition device. In this case, the input unit 22 acquires acoustic signals generated by the administrator's speech, performs voice recognition of the words spoken by the administrator, and inputs the recognition results as character string information to the management device 20. The voice recognition processing may be executed by the control unit 25. The input unit 22 may be configured in any manner as long as it is capable of inputting the administrator's instructions to the management device 20.

The output unit 23 outputs information in a form recognizable by an administrator. The output unit 23 may be a display device such as a liquid crystal display or an organic EL (Electro Luminescence) display. The output unit 23 may be an interface for connecting a display device to the management apparatus 20. In this case, the output unit 23 generates video signals for displaying image data and outputs the video signals to the display device connected thereto. The output unit 23 may be a device that outputs sound, such as a speaker. The output unit 23 may be an interface for connecting audio output devices such as speakers or headphones to the management apparatus 20. In this case, the output unit 23 generates audio signals for playing audio data and outputs the audio signals to the audio output device connected thereto. Furthermore, the output unit 23 may be configured as a touch panel integrated with the input unit 22.

The storage unit 24 is configured using storage devices such as a magnetic hard disk device or a semiconductor storage device. The storage unit 24 stores data used by the control unit 25. The storage unit 24 stores data necessary for processing by the control unit 25. The storage unit 24 functions as, for example, a content information storage unit 241, a customer attribute information storage unit 242, and an estimation model storage unit 243.

The content information storage unit 241 stores content information. The content information includes characters and images to be displayed on the establishment display device 43 of the establishment system 110. The content information includes, for example, information (item group data) related to items that may be offered at establishments under the management of the management system 100, information related to advertisements, and information related to games provided to customers.

The customer attribute information storage unit 242 stores a customer attribute information table containing information related to attributes of customers (hereinafter referred to as “customer attribute information”) who are registered in the management system 100. FIG. 13 is a diagram showing a specific example of the customer attribute information table. The customer attribute information table includes multiple customer attribute information records. Each customer attribute information record contains values such as customer identification information, attribute information, order history, and visit frequency. One customer attribute information record contains customer information registered by one customer.

The customer identification information is identification information assigned to each customer. The attribute information may include information related to gender and age group. The order history is information indicating the history of past orders made by that customer. The order history may show the history for a predetermined period going back in time, may show the history for a predetermined number of items going back in time, or may be defined in other ways. The establishment visit frequency is information indicating how frequently that customer visits the establishment. For example, predetermined categories (such as daily, several times per week, once per week, once per month, etc.) may be defined in advance, and information indicating which category that customer falls into May be used as the value of the establishment visit frequency.

The estimation model storage unit 243 stores estimation models. An estimation model is a model used to estimate items that a customer is likely to order based on customer attribute information. The estimation model may be configured as a trained model obtained through machine learning using training data. In this case, for example, as a combination of explanatory variables and objective variables in the training data, a combination of actual customer attribute information (e.g., attribute information and order history) and items actually ordered by customers corresponding to that customer attribute information may be used. Additionally, the combination of explanatory variables and objective variables may be defined in various ways. For example, a combination of past order history and classifications of actually ordered items may be used. For example, a combination of elapsed time from a first action (described later) and subsequently actually ordered items or item classifications may be used. For example, a combination of the time required from a customer's first action to second action (described later) and subsequently actually ordered items or item classifications may be used. The estimation model may also be information such as a Look Up Table (LUT) obtained through analytical processing based on past statistics.

The control unit 25 is configured using a processor such as a CPU (Central Processing Unit) and a memory (main storage device). The control unit 25 functions as a content control unit 251, a customer attribute information control unit 252, and a determination unit 253 by executing programs through the processor. All or part of the functions of the control unit 25 may be implemented using hardware such as an ASIC (Application Specific Integrated Circuit), PLD (Programmable Logic Device), or FPGA (Field Programmable Gate Array). The aforementioned program may be recorded on a computer-readable recording medium. The computer-readable recording medium includes portable media such as flexible disks, magneto-optical disks, ROM, CD-ROM, semiconductor storage devices (e.g., SSD: Solid State Drive), and storage devices such as hard disks and semiconductor storage devices built into computer systems. The aforementioned program may also be transmitted via telecommunications lines.

The content control unit 251 accepts registration of content information. For example, the content control unit 251 receives content information received via the communication unit 21 or content information input via the input unit 22. The content control unit 251 records the received content information in the content information storage unit 241. The content control unit 251 may transmit the content information stored in the content information storage unit 241 to all establishment systems 110 at predetermined timing (for example, once a day at a predetermined time). The content information transmitted from the content control unit 251 is, for example, received by the establishment control device 30 of each establishment system 110.

The customer attribute information control unit 252 controls the customer attribute information stored in the customer attribute information storage unit 242. For example, the customer attribute information control unit 252 may receive customer attribute information transmitted as a registration request from the customer terminal device 10, generate a new customer attribute information record using the received customer attribute information, and register it in the customer attribute information table. The customer attribute information control unit 252 may receive information indicating a customer's order history from the establishment control device 30 and update the order history in the customer attribute information.

When receiving a determination request, the determination unit 253 determines items to be preferentially displayed (hereinafter referred to as “priority display items”) for a customer indicated by customer attribute information included in the determination request. The determination unit 253 sends the priority display items, which are the determination results, to the source of the determination request. The source of the determination request (for example, the establishment control device 30) displays item images 432 of items included in the priority display items on the establishment display device 43 of the unit seat 44 where the customer is seated.

The determination unit 253 may estimate items that are likely to be ordered by customers and determine such estimated items as priority display items. Such determination may be performed by any processing. More specifically, the following describes the details.

For example, the determination unit 253 may estimate items likely to be ordered by a customer based on customer attribute information and an estimation model stored in the estimation model storage unit 243. The determination unit 253 may estimate items likely to be ordered based on attribute information of the customer included in the customer attribute information. For example, items may be estimated based on information such as gender, age group (age) included in the attribute information and the estimation model. The determination unit 253 may estimate items likely to be ordered based on the customer's past order history included in the customer attribute information. In this case, the determination unit 253 may estimate items likely to be ordered by the customer based on the estimation model stored in the estimation model storage unit 243 and the order history.

The determination unit 253 may determine priority display items based on predefined relationships between similar items, where items similar to items that the customer has ordered relatively frequently in the past are designated as priority display items. For example, if items related to ‘tuna’ have been frequently ordered in the past, item groups defined as similar to tuna may be determined as priority display items. For instance, items in the same or similar price range as items that have been ordered relatively frequently in the past may be determined as priority display items. If high-priced items have been ordered more frequently than a predetermined threshold in the past, item groups classified as high-priced items may be determined as priority display items. It is desirable that the relationship between price ranges and items be predefined.

For example, the determination unit 253 may determine priority display items based on the elapsed time from a customer's first action. As a specific example of the first action, there is entering the establishment. In this case, the determination unit 253 determines priority display items based on the elapsed time since the customer entered the establishment. Specifically, when the elapsed time since entering the establishment is shorter than a predetermined time (for example, 1 minute. 5 minutes), beverages (for example, soft drinks or alcoholic beverages) may be determined as priority display items. When the elapsed time since entering the establishment is longer than a predetermined time (for example, 30 minutes. 1 hour, or in cases where there is a usage time limit at the establishment, a predetermined time before the usage time limit (for example, 10 minutes before)), items classified as desserts or items classified as tea (including coffee) may be determined as priority display items.

Such determination may be made not based on the elapsed time since entering the establishment, but when certain conditions are met (for example, when no orders have been placed yet). Additionally, the determination may be made based on the elapsed time since the customer sat down, rather than the elapsed time since entering the establishment, or may be made based on the elapsed time since the registration of the seat identification information and customer identification information. In this case, the first action becomes the action of sitting down or the action of registering the seat identification information and customer identification information.

As another specific example of the first operation, there is an ordering operation. In this case, the determination unit 253 determines priority display items based on the elapsed time since the customer's last order. Specifically, when a predetermined length of time or more has elapsed since the customer's last order, the determination unit 253 may determine as priority display items: items categorized as finishing meals (such as rice bowls and ramen), items categorized as desserts, and items categorized as tea (including coffee).

For example, the determination unit 253 may determine priority display items based on the time required from a customer's first action to second action. For example, the first action and the second action may be specifically the second-to-last ordering action and the last ordering action, respectively. In other words, the priority display items may be determined based on the length of time required between orders. When this required time is longer than a predetermined threshold value, items classified as end-of-meal dishes (such as rice bowls and ramen), items classified as desserts, or items classified as tea (including coffee) may be determined as priority display items.

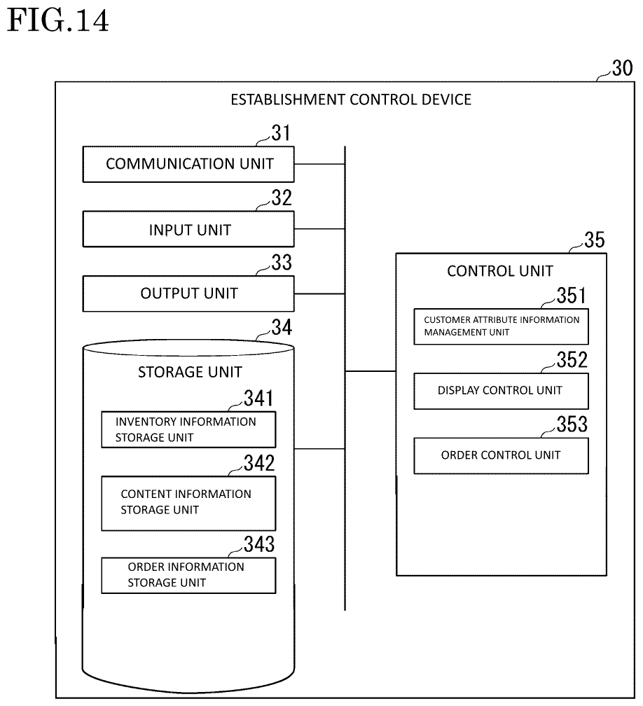

FIG. 14 is a schematic block diagram showing a specific example of the establishment control device 30. The establishment control device 30 is configured using information equipment such as a personal computer or a server device. The establishment control device 30 includes a communication unit 31, an input unit 32, an output unit 33, a storage unit 34, and a control unit 35.

The communication unit 31 is a communication device. The communication unit 31 may be configured as a network interface, for example, The communication unit 31 performs data communication with other devices via network 71 in response to control from the control unit 35. The communication unit 31 may be either a wireless communication device or a wired communication device.

The input unit 32 is configured using existing input devices such as a keyboard, pointing devices (mouse, tablet, etc.), buttons, and touch panel. The input unit 32 is operated by the user (establishment manager) when inputting instructions to the establishment control device 30. The input unit 32 may be an interface for connecting input devices to the establishment control device 30. In this case, the input unit 32 inputs signals to the establishment control device 30 generated in response to the establishment manager's input at the input device. The input unit 32 may also be configured using a microphone and voice recognition device. In this case, the input unit 32 acquires acoustic signals generated by the establishment manager's speech, performs voice recognition of the words spoken by the establishment manager, and inputs the recognized text information to the establishment control device 30. The voice recognition processing may be executed by the control unit 35. The input unit 32 may be configured in any way as long as it can input the establishment manager's instructions to the establishment control device 30.

The output unit 33 outputs information in a form recognizable by the establishment manager. The output unit 33 may be a display device such as a liquid crystal display or an organic EL display. The output unit 33 may be an interface for connecting a display device to the establishment control device 30. In this case, the output unit 33 generates video signals for displaying image data and outputs the video signals to the display device connected to itself. The output unit 33 may be a device that outputs sound, such as a speaker. The output unit 33 may be an interface for connecting audio output devices such as speakers or headphones to the establishment control device 30. In this case, the output unit 33 generates audio signals for playing audio data and outputs the audio signals to the audio output device connected to itself. The output unit 33 may also be configured as a touch panel integrated with the input unit 32.

The storage unit 34 is configured using storage devices such as a magnetic hard disk device or a semiconductor storage device. The storage unit 34 stores data used by the control unit 35. The storage unit 34 stores data necessary for processing by the control unit 35. The storage unit 34 functions as, for example, an inventory information storage unit 341, a content information storage unit 342, and an order information storage unit 343.

The inventory information storage unit 341 stores information related to inventory in the establishment where the apparatus (establishment control device 30) is installed. The inventory-related information may be input, for example, by an establishment administrator operating the input unit 32. The inventory-related information may be updated based on current inventory information, information about newly purchased items, and information about items provided to customers through orders.

The content information storage unit 342 stores content information. The content information stored in the content information storage unit 342 may be content information transmitted from the management device 20. The content information may include information related to items (food and beverages) that are out of stock in the establishment.

The order information storage unit 343 stores information related to the history of orders placed by customers at the establishment where the device (establishment control device 30) is installed. The order information storage unit 343 includes, for each unit seat 44, customer information (e.g., identification information), order information, information indicating whether items included in the order have been served, and information indicating whether payment has been made.

The control unit 35 is configured using a processor such as a CPU and a memory (main memory). The control unit 35, through program execution by the processor, functions as a customer attribute information management unit 351, a display control unit 352, and an order control unit 353. All or part of the functions of the control unit 35 may be implemented using hardware such as ASIC, PLD, or FPGA. The aforementioned program may be recorded on a computer-readable recording medium. The computer-readable recording medium includes portable media such as flexible disks, magneto-optical disks. ROM. CD-ROM, semiconductor storage devices (e.g., SSD: Solid State Drive), and storage devices such as hard disks and semiconductor storage devices built into computer systems. The aforementioned program may also be transmitted via telecommunications lines.

The customer attribute information management unit 351 manages information related to customers who visit the establishment where the device (establishment control device 30) is installed. The customer attribute information management unit 351 registers the unit seat 44 and customer attribute information in the order information storage unit 343 in association with each other. The association between the unit seat 44 and customer attribute information may be obtained through any type of processing.

For example, when a customer enters an establishment, a designated reader of the establishment system 110 may read code information displayed on the customer terminal device 10, and when the unit seat 44 to be provided to that customer is registered by an establishment employee, the unit seat 44 may be associated with customer attribute information. The unit seat 44 to be provided to the customer may be selected by the customer attribute information management unit 351 from among available unit seats 44 according to the number of customers. The code information read by the designated reader may include customer identification information. The customer attribute information management unit 351 obtains the customer identification information by decoding the read code information. The customer attribute information management unit 351 registers the seat identification information indicating the unit scat 44 in association with the customer identification information in the order information storage unit 343.

For example, the association between the unit seat 44 and customer attribute information may be performed by capturing code information displayed on the customer terminal device 10 with a predetermined imaging device 30 provided at the unit seat 44. In this case, the imaging device transmits seat identification information indicating the unit seat 44 where the device is installed, along with the captured code information, to the establishment control device 30. The customer attribute information management unit 351 registers the customer identification information indicated by the code information in association with the seat identification information in the order information storage unit 343.

For example, the association between the unit seat 44 and customer attribute information may be performed by having the customer read code information provided for each unit seat 44 using the customer terminal device 10. In this case, the customer terminal device 10 may transmit to the management device 20 the customer identification information stored in its own device along with the establishment identification information and seat identification information obtained by decoding the code information. The management device 20 transmits the customer identification information and seat identification information in association with each other to the establishment control device 30 of the establishment system 110 indicated by the establishment identification information. The customer attribute information management unit 351 registers the received customer identification information and seat identification information in association with each other in the order information storage unit 343.

The display control unit 352 controls the display of the establishment display device 43. When there is no particular operation by a customer, the display control unit 352 selects display target items from the item group data stored in the content information storage unit 342. At this time, the display control unit 352 may select items that are in stock at the establishment where the device is installed as display target items. The display control unit 352 displays the items included in the display target items on the establishment display device 43. For example, the display control unit 352 may randomly select items from among the items included in the display target items and display them on the establishment display device 43 in the order of selection.

The display control unit 352 may determine items to be preferentially displayed (priority display items) for each unit seat 44 based on predetermined criteria. For example, the display control unit 352 may send a determination request for each unit seat 44 to the management apparatus 20 and determine the priority display items according to the priority display items received as determination results. In this case, the display control unit 352 may determine the priority display items from among the items that can be provided to customers at the establishment where the apparatus is installed (for example, items in stock) among the priority display items determined by the management apparatus 20. The determination request includes information necessary for determining priority display items in the management apparatus 20. Items determined as priority display items are displayed on the establishment display device 43 at a higher frequency than items not determined as priority display items. Items displayed other than priority display items may be determined according to normal display control. For example, items displayed other than priority display items may be randomly selected from among the items included in the display target items as described above.

The display control unit 352 may control the display such that. among the number of items displayed per unit timing, a predetermined number (hereinafter referred to as “priority display number”) of item images 432 are displayed for items determined as priority display items. The unit timing may be defined as, for example, a unit time (such as 30 seconds, 1 minute, etc.) or as a unit number of items (such as 5 items, 10 items). When the unit timing is defined as 30 seconds and the priority display number is defined as 5, the display is controlled such that 5 priority display items are displayed within a 30-second period.

The order control unit 353 accepts orders according to customer operations. For example, when an order is placed based on customer operations as explained in FIGS. 4-11, the order control unit 353 may register the ordered items in association with the unit seat 44 where the order was placed in the order information storage unit 343. The order control unit 353 displays the ordered items in association with the unit seat 44 where the order was placed on the kitchen display device 40.

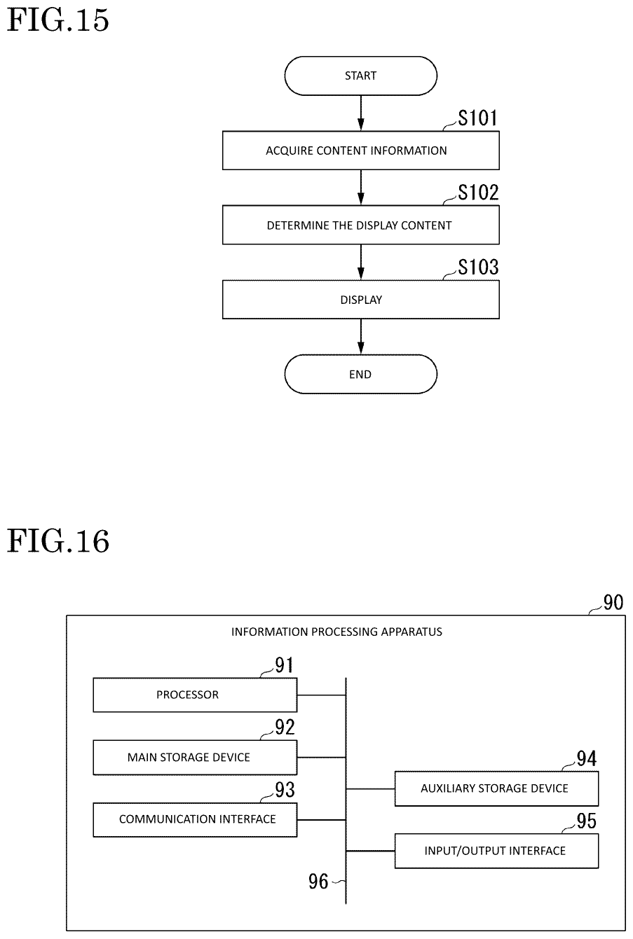

FIG. 15 is a flowchart showing a specific example of the processing performed by the establishment control device 30. First, the display control unit 352 receives and acquires content information from the management device 20 (step S101). The display control unit 352 records the received content information in the content information storage unit 342. The display control unit 352 determines the display content for each establishment display device 43 (step S102) and causes each establishment display device 43 to display images (step S103). By repeatedly executing the processing of steps S102 and S103, item images and other content are displayed on each establishment display device 43.

FIG. 16 is a diagram showing an outline of an example hardware configuration of an information processing apparatus 90 applicable to the present embodiment. The information processing apparatus 90 includes a processor 91, a main storage device 92, a communication interface 93, an auxiliary storage device 94, an input/output interface 95, and an internal bus 96. The processor 91, main storage device 92, communication interface 93, auxiliary storage device 94, and input/output interface 95 are communicably connected to each other via the internal bus 96. The information processing apparatus 90 may be applied to, for example, the management apparatus 20 and the establishment control apparatus 30. In this case, for example, the communication units 21 and 31 may be configured using the communication interface 93. For example, the storage units 24 and 34 may be configured using the auxiliary storage device 94. Furthermore, the control units 25 and 35 may be configured using the processor 91 and the main storage device 92.

### Examples of Variations

In the present embodiment, while the management device 20 and the establishment control device 30 are configured as separate devices, they may be configured as an integrated device. Additionally, a part of the management device 20 and the establishment control device 30 may be configured as an integrated device. For example, the establishment control device 30 may be configured to include the estimation model storage unit 243 and the determination unit 253. When configured in this manner, the establishment control device 30 can determine priority display items without communicating with (sending determination requests to) the management device 20.

The management device 20 may be implemented using multiple information processing devices. For example, the management device 20 may be implemented using cloud-based devices or similar equipment. For example, in the management device 20, the storage unit 24 and the control unit 25 may each be implemented in different information processing devices. For example, the storage unit 24 of the management device 20 may be implemented in a distributed manner across multiple information processing devices. For example, the control unit 25 of the management device 20 may be implemented in a distributed manner across multiple information processing devices.

While the embodiments of the present invention have been described in detail with reference to the drawings, the specific configuration is not limited to these embodiments, and includes any design modifications and the like within the scope that does not depart from the spirit of the present invention.

### DESCRIPTION OF REFERENCE NUMERALS

100 Management System
110 Establish Management System
10 Customer Terminal Device
20 Control Unit
21 Communication Unit
22 Input Unit
23 Output Unit
24 Storage Unit
25 Control Unit
30 Establishment Control Device (an example of a control device)
31 Communication Unit
32 Input Unit
33 Output Unit
34 Storage Unit
35 Control Unit
40 Kitchen Display System
41 Conveyance Control Device
42 Conveyance Device
421 Collection Window
43 Establishment Display Device (an example of a display device)
431 Information Display Area
432 Item Images
433 Order Operation Area
434 Order Button
435 Order Candidate Area
436 Menu Screen
44 Unit Seat

What is claimed is:

1. A control device for controlling a display device provided at a seat, the control device comprising:
a processor and
memory storing instructions that, when executed by the processor, cause the control device to:
display an order screen on the display device, the order screen being used by a customer seated in the seat to order items, wherein
the order screen includes
an item moving area, which is a region for displaying each of a plurality of item images so as to move in a predetermined direction along a lane;
an order candidate area provided at a position that does not overlap the item moving area; and
an order execution button provided at a position that does not overlap the item moving area; and the instructions further cause the control device to:
accept selection of an item displayed in the item moving area;
move the item, for which selection has been accepted, from the item moving area to the order candidate area and display it therein;
accept operation of the order execution button; and
execute an order for the item displayed in the order candidate area when the operation has been accepted.

2. A control device for controlling a display device provided at a seat, the control device comprising:
a processor and
memory storing instructions that, when executed by the processor, cause the control device to:
display an order screen on the display device, the order screen being used by a customer seated in the seat to order items, wherein
the order screen includes an item moving area, which is a region for displaying each of a plurality of item images to be ordered so as to move in a predetermined direction along a lane; and
the instructions further cause the control device to:
acquire information relating to the customer; and
select, as priority display items to be preferentially displayed to the customer, items among the plurality of items whose images are displayed in the item moving area, based on the information relating to the customer.

3. A control device for controlling a display device provided at a seat, the control device comprising:
a processor and
memory storing instructions that, when executed by the processor, cause the control device to:
display an order screen on the display device, the order screen being used by a customer seated in the seat to order items, wherein
the order screen includes an item moving area, which is a region for displaying each of a plurality of images, including images of items to be ordered and images indicating campaign information, so as to move in a predetermined direction along a lane; and
the instructions further cause the control device to:
accept a predetermined operation with respect to an image indicating the campaign information; and
display a campaign display area, when the predetermined operation has been accepted, showing details of a campaign corresponding to the campaign information on the order screen.

4. A control device for controlling a display device provided at a seat, the control device comprising:
a processor and
memory storing instructions that, when executed by the processor, cause the control device to:
display an order screen on the display device, the order screen being used by a customer seated in the seat to order items, wherein
the order screen includes an item moving area, which is a region for displaying each of a plurality of images of items to be ordered so as to move in a predetermined direction along a lane; and
the instructions further cause the control device to:
accept a flick operation having a component in a direction opposite to the predetermined direction; and
temporarily display each of the plurality of images of items so as to move in the opposite direction, when the flick operation has been accepted.
